(19) United States
(12) Patent Application Publication
(10) Pub. No.: US 2012/0257856 A1
(43) Pub. Date: Oct. 11, 2012

(54) SMALL FORM FACTOR PLUGGABLE UNIT

(75) Inventors: Renaud LAVOIE, Laval (CA); Eric DUDEMAINE, Crabtree (CA); Mathieu ROUSSEL, Saint-Eustache (CA)

(73) Assignee: EMBRYONIX DESIGN INC., Laval, QC (CA)

(21) Appl. No.: 13/082,073

(22) Filed: Apr. 7, 2011

(51) Int. Cl. G02B 6/36

(52) U.S. Cl. 385/53

(57) ABSTRACT

The present relates to a small form-factor pluggable (SFP) unit. The SFP unit comprises an optical guide for receiving and guiding an optical component to be optically connected within the SFP unit.

The present relates to a small form factor pluggable unit, and more particularly to a small form factor pluggable unit with two frontal connectors.

### BACKGROUND

Small Form-factor Pluggable (SFP) units are standardized units adapted to be inserted within a chassis. The standard describes the size of the SFP unit, so as to ensure that all SFP fully-compliant and partially-compliant units may be inserted smoothly within one same chassis, i.e. inside cages, ganged cages, superposed cages and belly-to-belly cages.

SFP units may be used with various types of exterior connectors, such as coaxial connectors, optical connectors, and any other type of electrical connector.

As SFP units are small in dimensions, it is possible to limit the size, of the chassis required to host several units simultaneously. And with the constant reduction of the electric, electronic and optic components used within the SFP units, the only limitation known today is due to the size of the connectors from which signals are received and transmitted there from.

However, such miniaturization of the SFP renders difficult the design of SFP units with one or more frontal connector. There is thus a need for an SFP unit capable of simultaneously housing multiple frontal connectors such as: coaxial connectors, DIN 1.0/2.3, SMA, SMB, SMC, HD BNC, mini BNC, etc, in a way that ganged cages are supported without restrictions.

### BRIEF DESCRIPTION OF THE DRAWINGS

In the appended drawings, provided for exemplary purposes only, similar references denote like parts:

FIG. 1 is a top elevation view of a SFP unit in accordance with an aspect;

FIG. 2 is a side elevation view of the SFP unit in accordance With another aspect;

FIG. 3 is a front elevation view of the SFP unit in accordance with an aspect;

FIG. 4 is a front elevation view of the SFP unit in accordance with another aspect;

FIG. 5 is a perspective view of a cap adapted to fit in the aperture;

FIG. 6 is a top elevation view of a SFP unit in accordance with another aspect; and

FIG. 7 is a perspective view of the SFP unit in accordance with another aspect.

### DETAILED DESCRIPTION

The foregoing and other features of the present will become more apparent upon reading of the following non-restrictive description of examples of implementation thereof, given by way of illustration only with reference to the accompanying drawings.

The present relates to a small form-factor pluggable (SFP) unit with particular frontal properties. More particularly, the SFP unit comprises a housing, a back panel, a front panel, and at least two connectors. The housing defines a top, a bottom and two sides, and corresponds at least partially to standardized dimensions. The back panel is affixed to a back section of the housing. The front panel is affixed to a front section of the housing. The front panel comprises at least two apertures defining, there between a non-horizontal line, or are said to be offset. The at least two connectors are adapted to be inserted and affixed in the apertures of the front panel.

In the context of the present SFP unit, the following terminology is used:

SFP: Small Form Factor Pluggable Unit corresponding to SFP and SFP+standards.

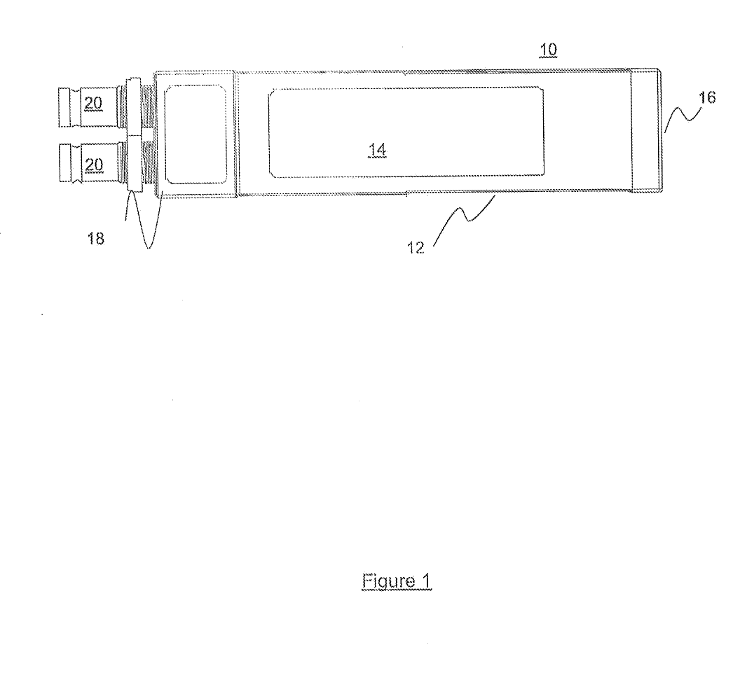

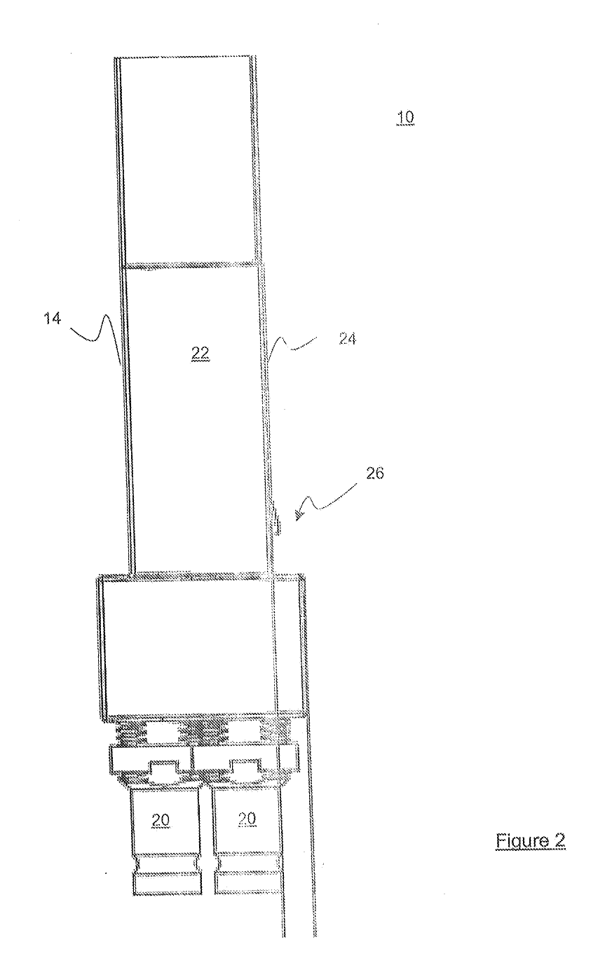

Reference is now made to concurrently to FIGS. 1 and 2, where FIG. 1 is a top elevation ‘view’ of a SFP unit 10 in accordance With an aspect, and FIG. 2 is a side elevation view. The SFP unit 10 comprises a housing 12. The housing defines a top portion 14, a bottom portion 24, and two sides 22. The housing 12 is at least partially of dimensions in compliance with the SFP and SFP+standards or having functional dimensions based on the SFP or SFP+standards.

The SFP unit 10 further comprises a back panel 16 affixed to the housing 12. Although not shown, the back panel may comprise for example an electrical or an optical connector.

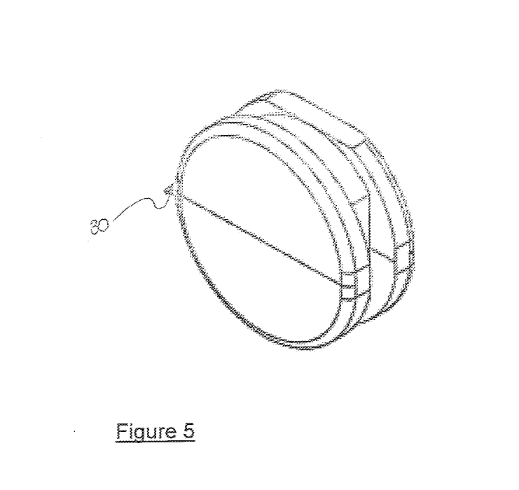

The SFP unit 10 further comprises a front panel 18 affixed to the housing 12. The front panel defines at least two apertures, which, are not horizontally aligned. Two of the apertures define there between a non-horizontal line, such as for example a slope, or a vertical line (between the top and bottom portion), and are thus in an offset geometry with respect to an imaginary horizontal line on the front panel. At least two apertures are adapted for receiving connectors 20 or when not in used a cap 30 (as shown on FIG. 5).

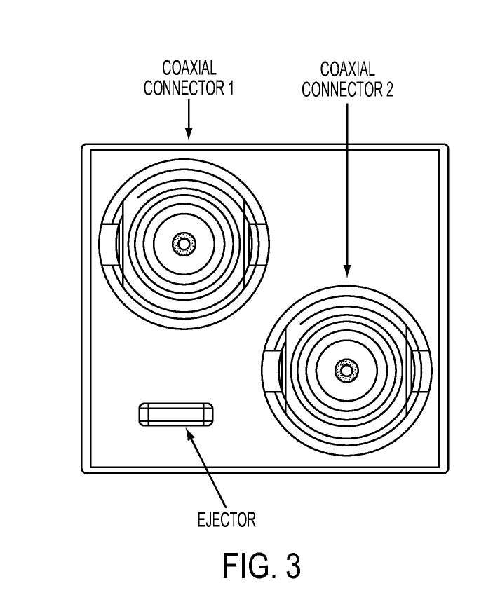

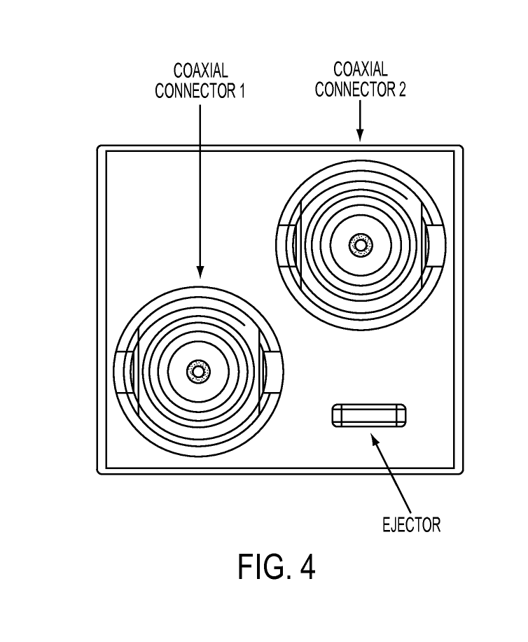

Reference is now made to FIGS. 3 and 4, which respectively depict front elevation views of the SFP unit in accordance with different aspects. The connectors 20 are inserted in the apertures, of the front panel 18 of the SFP unit 10. Each of the connectors may consist of any of the following: a coaxial connector, an optical connector, or any type of electrical connector suited to be inserted within an SFP unit. Although FIGS. 3 and 4 depict coaxial connectors and apertures defining a sloped line, the present SFP unit is not limited to such an implementation.

The SFP unit 10 further comprises an ejection mechanism. The ejection mechanism is integrated within the housing 12, and comprises an actuator located in the front panel. A latch 26 of the ejection mechanism is shown on FIG. 2.

Reference is now made to FIG. 5 is a perspective view of a cap adapted to fit in the aperture. When only one connector 20 is used with the SFP unit 10, the cap 30 may be inserted within the unused aperture, so as to completely close the front panel 18.

Because of its particular front panel 18, the present SFP unit 10 allows ganged cages, superposed cages configuration without any interference, blocking cages. The ejection mechanism may be internally to the SFP unit 10, increasing robustness and ease of use. However, a fully external or partially external ejection mechanism could also be used. Multiple coaxial connectors 20 can be simultaneously supported with the present SFP unit 10.

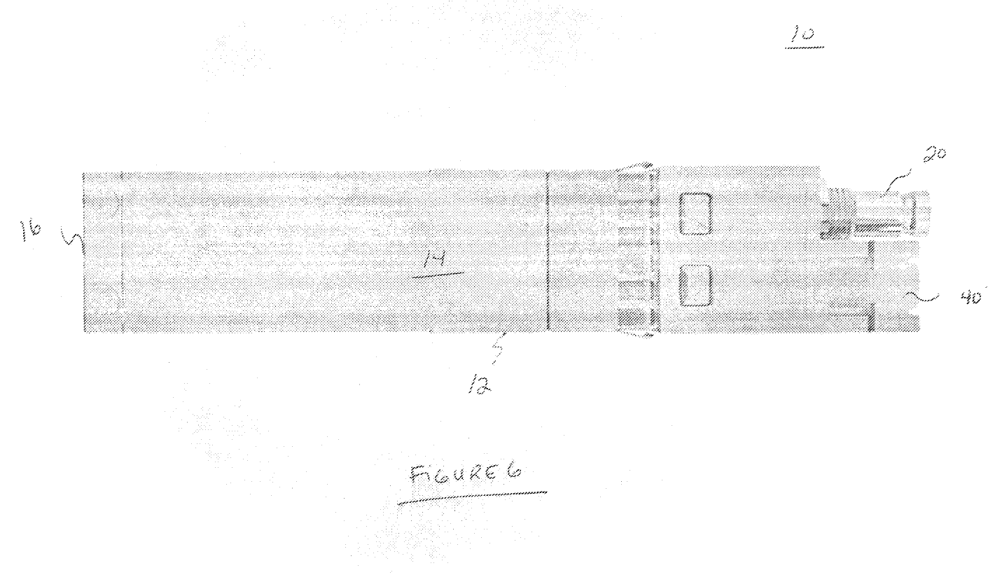

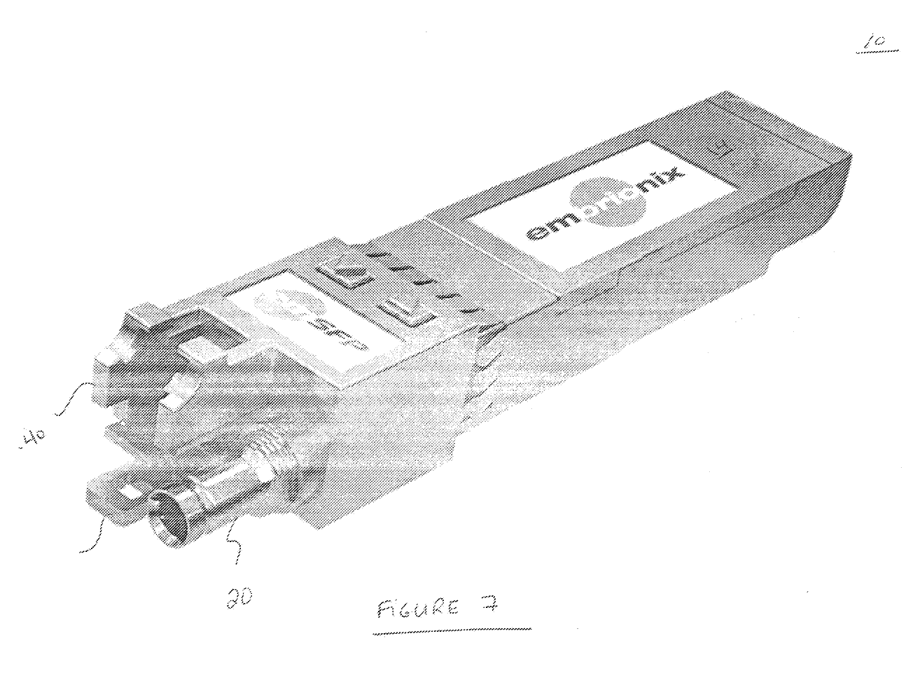

Reference is now made to FIGS. 6 and 7, which depict another aspect of the present SFP unit 10. In this particular aspect, at least one of the connector is an optical connector with optical connection inside the SFP unit 10. More precisely, in this particular aspect, an optical guide 40 is provided in the front of the SFP unit 10, to receive and guide an optical component, such as an optical fiber and/or its optical connector, for connection within the SFP unit 10. The optical guide 40 surrounds partially or completely one of the apertures which permits passage of the optical component into the SFP unit.

Although FIGS. 6 and 7 both depict the SFP unit 10 with one electrical connector 20 and one optical guide 40, the present aspect is not limited to such embodiment. For example, the SFP unit 10 could comprise two optical guides 40, and no connector 20. The connector 20 and the optical guide 40 could be in an offset, disposition, or aligned. When two optical guides 40 are present on the SFP unit 10, the two optical guides 40 could be arranged in an offset disposition on the front or the SFP unit, or be aligned, whichever is the most convenient.

Because optical components are more fragile than electric connectors, the optical guide 40 provides a simple way of inserting an optical connector (not shown), within the SFP unit 10, for optical connection therein in any manner known in the art. The optical guide 40 could be of any shape and or size suitable for facilitating optical connection within the SFP unit 10.

Although the present SFP unit has been described in the foregoing description by way of illustrative embodiments thereof, these embodiments can be modified at will, within the scope of the appended claims without departing from the spirit and nature of the present SFP unit.

What is claimed is:

1. A small form-factor pluggable (SFP) unit comprising:
an optical guide for receiving and guiding an optical component to be optically connected within the SFP unit.

2. The SFP unit of claim 1, wherein the standardized dimensions of the housing corresponds to any of the following: Small Form-Factor Pluggable standard and Small For-Factor Pluggable+standard.

3. The SFP unit of claim 1, further comprising:
a housing, the housing defining a top, a bottom and two sides, the housing corresponding at least partially to standardized dimensions;
a back panel affixed to the housing; and
a front panel affixed to the housing, the front panel defining at least two apertures,
wherein the optical guide is on the front panel, and partially surrounds one of the at least apertures.

4. The SFP unit of claim 3, further comprising an ejection mechanism integrated to the housing, the ejection mechanism comprising an actuator located in the front panel.

5. The SFP unit of claim 3, wherein the apertures defining there between a non-horizontal line.

6. The SFP unit of claim 3, wherein one of the apertures receives an electrical connector, and the other permits passage of the optical component into the SFP unit.

7. The SFP unit of claim 3, wherein the two of the apertures define a sloped line there between.

8. The SFP unit of claim 3, wherein two of the apertures define a vertical line there between.
